(19) United States
(12) Patent Application Publication
(10) Pub. No.: US 2007/0262591 A1
(43) Pub. Date: Nov. 15, 2007

(54) Latch system

(76) Inventors: Stephen John Wright, West Midlands (GB); Nigel Victor Spurr, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 11/714,076

(22) Filed: Mar. 5, 2007

(30) Foreign Application Priority Data
Mar. 6, 2006 (GB) 0604478.8

(51) Int. Cl. E05C 3/16

(52) U.S. Cl. 292/216

(57) ABSTRACT

A latch system for an aperture closure includes a latch, an auxiliary retention device remote from the latch, an engaging member remote from the auxiliary retention device and a transmission path operably connecting the engaging member with the auxiliary retention device. The latch system is arranged such that movement of the aperture closure from an open position to a closed position causes the latch to move to the closed position and causes movement of the engaging member to cause the transmission path to move the auxiliary retention device to a closed position.

### REFERENCE TO RELATED APPLICATIONS

This application claims priority to United Kingdom Patent Application GB 0604478.8 filed on Mar. 6, 2006.

### BACKGROUND OF THE INVENTION

The present invention relates generally to latch systems for releasably holding aperture closures, such as vehicle doors, in a closed position. The invention can be used with land vehicle doors, such as cars, lorries, vans and the like.

Known cars (automobiles) have passenger doors which are hinged at a front of the door and have a single self engaging latch at a back of the door to allow the door to be held in a closed position. Typically, the latch is positioned partially up the door, but below a waist line (belt line) of the door. While such an arrangement is satisfactory for keeping the door closed under normal operating conditions, parts of the door remote from the hinges and the latch can be deformed inwardly in the event of a road traffic accident, thereby endangering occupants of the vehicle.

The latch is typically of a rotating claw construction, and the claw is held in place by a rotating pawl. The latch is self engaging i.e., it automatically self engages upon closing of the door. Once the door has been moved to a fully closed position, no subsequent actions are required by the door operator to latch the latch. In summary, as the door is closed, a striker on the door frame enters a mouth of the latch and causes the rotating claw to rotate. Once the claw has rotated sufficiently, the pawl is spring biased to automatically locate between an abutment of the claw to hold the claw in the closed position.

EP1149968 shows a vehicle door which is hinged at a front of the door and includes a master latch at a rear of the door below a belt line of the door. However, there are several self engaging longitudinally slideable auxiliary latches spaced around a periphery of the door. In this case, three self engaging auxiliary latches are positioned above the belt line, and three are positioned below the belt line. The auxiliary latch bolt automatically self engages upon closing of the door. A transmission path operably couples each auxiliary sliding latch to a master latch. However, the only purpose of the transmission path is to enable the self-engaging auxiliary latches to be disengaged. The transmission path fulfils no other purpose.

It is also known to provide sports cars and coupes with a front door hinged at a front, a rear door hinged at a rear, and no “B” pillar. Under such circumstances, the front door (the master door) must be opened before the rear door (the slave door) is opened. The rear door must be closed before the front door is closed. Because the rear door has no “B” pillar to close against, the rear door includes a self engaging latch at a top front part of the door and a further self engaging latch at a bottom front part of the door. Both the top latch and the bottom latch include a rotating claw and an associated pawl. Upon closing of the rear door, the top latch claw will engage a striker mounted on a roof. When fully closed, the top latch pawl will hold the top latch claw in the closed position, thereby retaining the roof mounted striker.

Similarly, upon closing, the bottom latch will retain a lower sill mounted striker by virtue of the pawl of the lower latch engaging the claw.

However, such an arrangement is complicated by the fact that both the top latch and the bottom latch must engage at the same time and must release at the same time. Thus, problems arise in synchronizing the operation of the two latches.

Similar synchronizing problems arise in EP1149968 as it is difficult to ensure that all latches are properly engaged at the same time. It is also difficult to ensure that all latches release at the same time.

U.S. Pat. No. 3,206,239 shows a vehicle door hinged at a front by four hinges, effectively forming a four bar linkage arrangement to allow for translatory opening movement as the door rotates about a moveable axis. To ensure secure closure of the door, the arrangement includes a stabilizing latching mechanism in the form of a bell crank bolt lever which engages a keep on a door frame. A second lever is connected to the bolt lever by a cable on a side of the door opposite from the bolt lever and is engageable with the door frame to actuate the bolt lever. The bolt lever and the second lever are positioned at the same vertical position (same height) on the door, i.e., they are horizontally aligned. The bolt lever is positioned between the two hinges because the retaining force is most needed in this position.

### SUMMARY OF THE INVENTION

The present invention provides a latch system for an aperture closure including a latch, an auxiliary retention device remote from the latch, an engaging member remote from the auxiliary retention device and a transmission path operably connecting the engaging member with the auxiliary retention device. The engaging member is positioned at a different height from the auxiliary retention device.

The latch system is arranged such that movement of the aperture closure from an open position to a closed position causes the latch to move to the closed position and causes movement of the engaging member to cause the transmission path to move the auxiliary retention device to a closed position.

Another aspect of the present invention provides a latch system including a latch having a latch bolt, a pawl, an auxiliary retention device remote from the latch and a transmission path operably connecting the latch bolt to the auxiliary retention device. Closing of the latch causes the transmission path to move the auxiliary retention device to a closed position.

Another aspect of the present invention provides a method of closing an aperture closure and retaining the aperture closure in a closed position. The method includes the steps of providing an aperture, providing an aperture closure in an open position, providing a self engaging latch, providing an auxiliary retention device remote from the latch, providing an actuator system on one of the aperture and aperture closure remote from the auxiliary retention device, and providing a transmission path operably connecting the actuator system and the auxiliary retention device. The method further including the step of moving the aperture closure to the closed position so as to: a) move the latch to the closed position to self latch and b) cause the actuator system to actuate by engagement with another one of the aperture and aperture closure, thereby causing the transmission path to move the auxiliary retention device to the closed position.

### BRIEF DESCRIPTION OF THE DRAWINGS

The invention will now be described, by way of example, with reference to the accompanying drawings, in which:

FIG. 1 is a side view of a car incorporating a first embodiment of a latch system (shown schematically) according to the present invention;

FIG. 2 is an end view of a front door of FIG. 1 in an open position;

FIG. 2A shows certain features of the latch system of FIG. 1 in a closed position;

FIG. 3 shows certain features of the latch system of FIG. 1 in an open position;

FIG. 4 shows certain features of the latch system of FIG. 1 in a closed position;

FIG. 5 shows certain features of the latch system of FIG. 1 in a closed position;

FIG. 6 shows certain features of the latch system of FIG. 1 in a closed position;

FIG. 7 shows certain features of the latch system of FIG. 1 in a closed position;

FIG. 8 shows certain features of the latch system of FIG. 1 in a closed position;

FIG. 9 shows certain features of the latch system of FIG. 1 in a closed position;

FIG. 10 shows certain features of the latch system of FIG. 1 in a closed position;

FIG. 11 shows certain features of the latch system of FIG. 1 in a closed position;

FIG. 12 shows a second embodiment of a latch system according to the present invention;

FIG. 13 shows alternative positioning of major components of a latch system (shown schematically) according to the present invention;

FIG. 14 shows alternative positioning of major components of a latch system (shown schematically) according to the present invention;

FIG. 15 shows alternative positioning of major components of a latch system (shown schematically) according to the present invention; and

FIG. 16 shows alternative positioning of major components of a latch system (shown schematically) according to the present invention.

### DETAILED DESCRIPTION OF THE PREFERRED EMBODIMENT

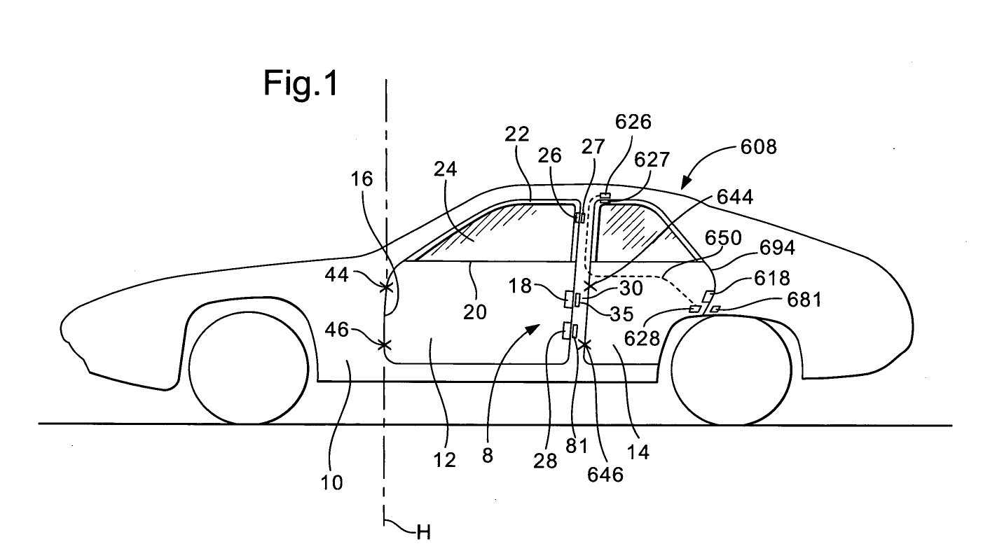

FIG. 1 shows a land vehicle, in this case a car 10, having a front door 12 and a rear door 14. A front door 12 is hinged at a front end 16 and includes a latch 18 positioned at a rear of the front door 12 below the belt line 20. The front door 12 includes a door frame 22 and a window glass 24. An auxiliary retention device 26 is provided in the door frame 22 above the belt line 20 and is actuated by an actuator system 28 (which is positioned below the belt line), as will be described in more detail below.

A latch system 8 primarily includes the latch 18, the auxiliary retention device 26, and the actuator system 28. A latch 18 is a conventional self latching latch, and as such will only be described briefly.

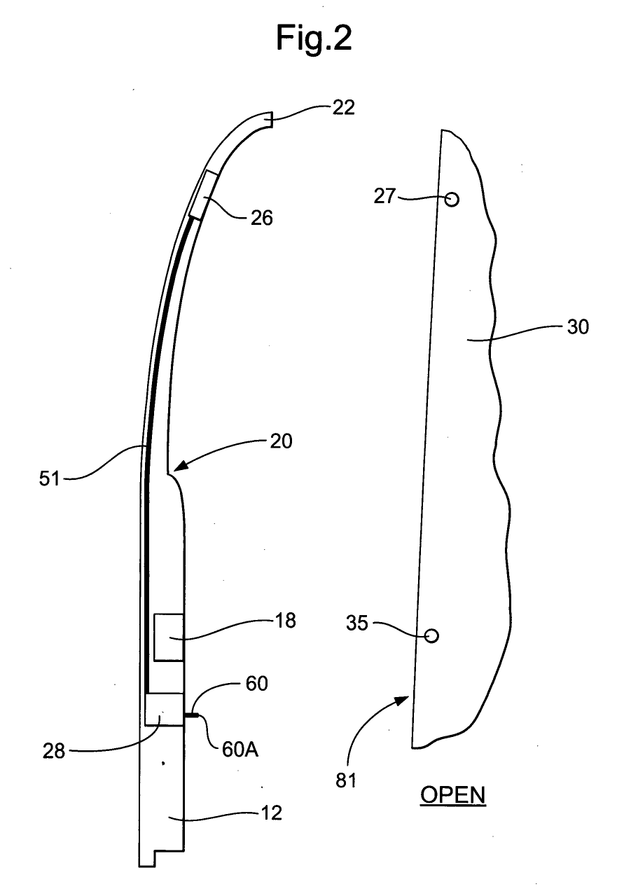

FIG. 2A shows a part view of the latch 18 which includes a latch chassis 31 which is mounted on the front door 12. The latch 18 includes a latch bolt in the form of a rotating claw 32, which is pivotally mounted about a pivot 33. The rotating claw 32 includes a mouth 34 for releasably retaining the latch striker 35 which is mounted on a B pillar 30. The rotating claw 32 includes a closed abutment 36 and a first safety abutment 37. A rotating pawl 38 is pivotally mounted at a pivot 39 to the latch chassis 31. The pawl 38 includes a pawl tooth 40 which engages the closed abutment 36 when the latch 18 is fully closed and engages the first safety abutment 37 when the latch 18 is in the first safety position, i.e., when the striker is retained within the mouth 34 but the door is not fully closed. A release mechanism 41 can be operated to rotate the pawl 38 in a counter-clockwise direction to disengage the pawl tooth 40 from the closed abutment 36, thereby allowing the rotating claw 32 to rotate in a counter-clockwise direction and release the latch striker 35 to enable the door to be pivoted open. The release mechanism 41 can be an inside door handle, and/or an outside door handle, and/or a release motor, and/or any other known release system.

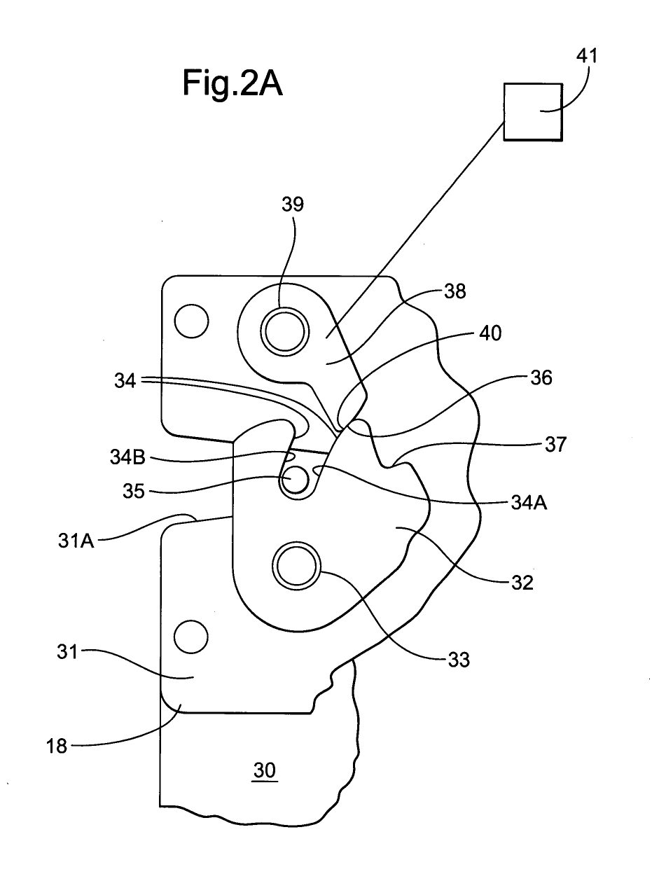

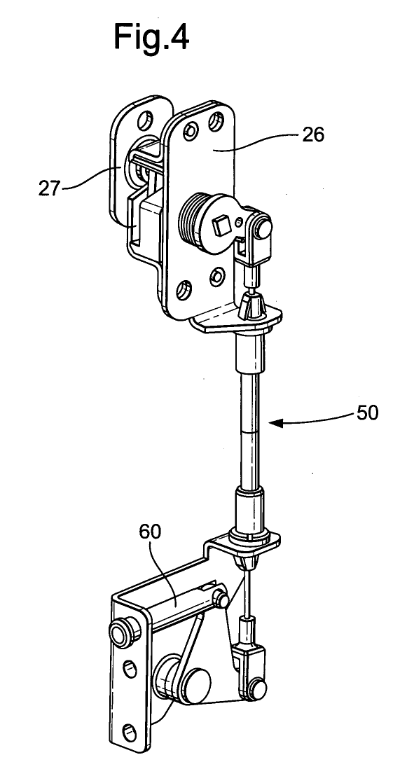

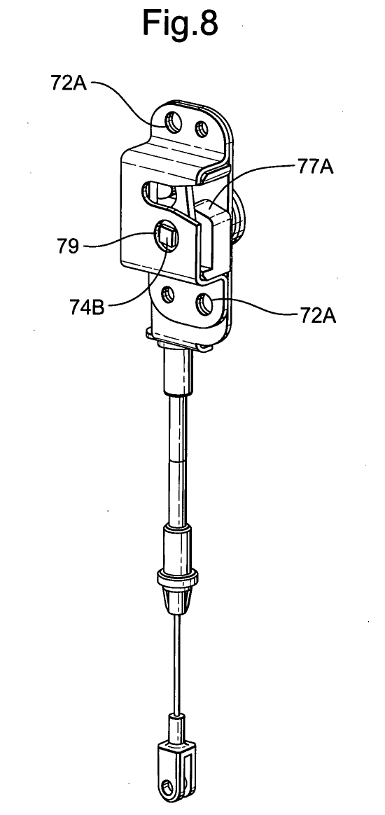

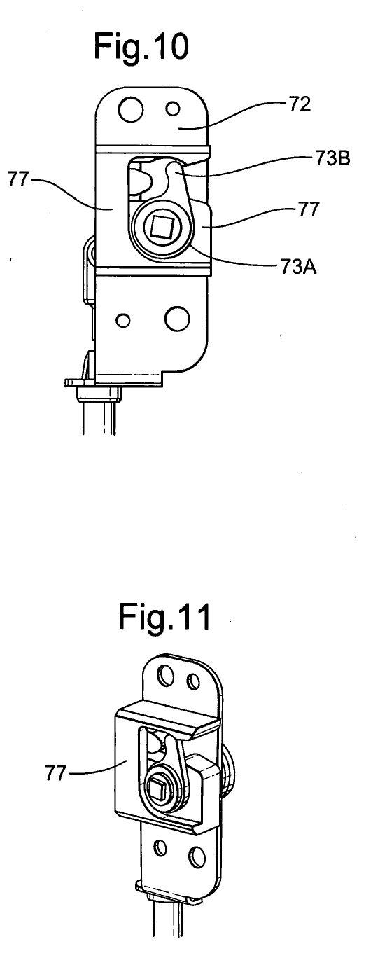

FIGS. 3 to 11 show in more detail certain features of the latch system 8, the main components of which are the actuator system 28, the auxiliary retention device 26, a transmission path 50 and an auxiliary retention device retention pin 27 (also known as a retention keep).

The actuator system 28 includes a plunger 60 which is slideably moveable in a direction of an arrow A within a hole 61 in a plate 62. The plate 62 is secured to the front door 12 by fixings (typically nuts and bolts) which pass through holes 64. A bell crank 65 is pivotally mounted at a pivot 66 to the plate 62, and a pin 67 pivotally connects an end 60B of the plunger 60 with the bell crank 65. An end 60A (also known as an engaging member) of the plunger 60 engages an abutment region 81 of the B pillar 30, as will be described in more detail below.

The main component of the transmission path 50 is a bowden cable 51 which includes a cable outer 52 and a cable inner 53. The cable outer 52 has end fittings 52A and 52B. The end fitting 52A is snap fit in a hole of a tab 68 of the plate 62. The end fitting 52B is snap fit in a hole of a tab 70 of the auxiliary retention device 26. The cable inner 53 includes end fittings 53A and 53B. The end fitting 53A is pivotally mounted via a pin 54 to an arm 65A of the bell crank 65.

The main components of the auxiliary retention device 26 are a plate 71, a housing 72, a hook 73, a shaft 74, a drive lever 75, a spring 76 and a striker guide 77.

The plate 71 is generally rectangular and includes the tab 70 bent at one end thereof. The plate 71 includes holes 71A to allow the auxiliary retention device 26 to be secured to the door via fixings 78 (in this case screws and nuts).

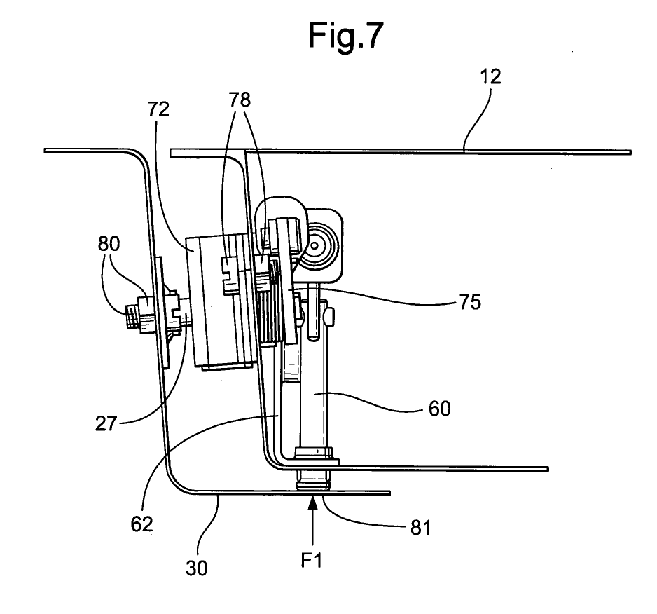

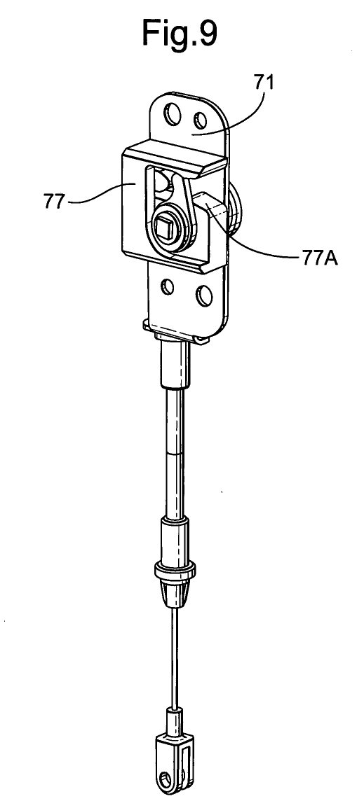

The housing 72 is generally rectangular (see FIG. 10) and is bent into a top hat section (see FIG. 8). The housing 72 includes holes 72A which corresponds with the holes 71A. The housing 72 includes a mouth 72B which receives the retention pin 27.

The retention pin 27 (also known as a retention keep) is mounted on a plate 27A. The plate 27A is secured by fixings 80 (in this case nuts and bolts) to the B pillar 30.

The striker guide 77 is mounted within the top hat section of the housing 72 and is sandwiched between the housing 72 and the plate 71. The striker guide 77 includes a mouth 77A which corresponds with the mouth 72B. The mouth 77A acts to guide the retention pin 27 as the door is closed. Typically, the striker guide 77 will be made of a low friction material, such as a plastics material.

The shaft 74 includes a first end 74A having a square profile and a second end 74B also having a square profile. The first end 74A engages with a square hole in the drive lever 75 to ensure the drive lever 75 is rotationally fast with the shaft 74. The second end 74B engages with a square hole in the hook 73 to ensure that the hook 73 is rotationally fast with the shaft 74. Accordingly, the hook 73 is rotationally fast with the drive lever 75.

In more detail, the shaft 74 is rotatable about a bearing provided by a circular hole 79 provided in the housing 72, a circular hole (not shown) provided in the striker guide, and a circular hole (not shown) provided in the plate 71.

The hook 73 has a generally circular portion 73A (see FIG. 10), which is concentric with the shaft 74, and an arm 73B projects from the generally circular portion 73A.

The spring 76 has one end 76A engaged with the drive lever 75 and another end (not shown) engaged with the plate 71. The spring 76 is arranged to bias an arm 75A of the drive lever 75 generally upwardly when viewing FIG. 3.

A comparison between FIG. 2A and FIG. 10 shows that the rotating claw 32 is significantly different from the hook 73. In particular, whereas the rotating claw 32 has a clearly defined mouth 34 which is generally U-shaped, no such mouth exists on the hook 73. Furthermore, whereas the rotating claw 32 includes a closed abutment 36 and a first safety abutment 37, no such abutments exist on the hook 73. Furthermore, the latch 18 includes a pawl 38 which acts directly on the rotating claw 32, whereas no such pawl acting directly on the hook 73 exists.

Operation of the latch system 8 is as follows. With the door in the open position, as shown in FIGS. 2 and 3, the latch striker 35 is positioned remotely from the latch 18, and the retention pin 27 is positioned remotely from the auxiliary retention device 26. Furthermore, an abutment region 81 of the B pillar 30 is positioned remotely from end 60A of the plunger 60.

As the door is closed, the mouth 77A of the auxiliary retention device 26 approaches the retention pin 27, the mouth 31A of the latch chassis 31 approaches the latch striker 35, and the end 60A of the plunger 60 approaches the abutment region 81.

Continued closing of the door will cause the latch striker 35 to engage the striker edge 34A of the mouth 34 (note that this occurs when the rotating claw 32 is in the open position, not shown). At this stage, the retention pin 27 will have started to enter the mouth 72B, and in particular will have passed the end 73C of the hook 73 (note that this is occurring with the hook 73 in the open position as shown in FIG. 3). At this stage, the end 60A of the plunger 60 will have just contacted the abutment region 81.

Continued closing of the door will result in the latch striker 35 acting on the striker edge 34A of the rotating claw 32, causing the rotating claw 32 to rotate towards the closed position. As this rotation occurs, the plunger 60 is moving in the direction of an arrow B relative to the door. In other words, the end 60A of the plunger 60 is stationary (because it is in engagement with the stationary abutment region 81 of the door pillar), and the door continues to move in the direction of an arrow C in a closing direction. The relative movement between the plunger 60 and the plate 62 causes the bell crank 65 to rotate in a clockwise direction when viewing FIG. 3, thereby moving the cable inner end fitting 53A in a generally downwardly direction, which in turn moves the cable inner end fitting 53B in a generally downwardly direction, which causes the drive lever 75 to rotate in a clockwise direction when viewing FIG. 3, which simultaneously causes the hook 73 to rotate in a clockwise direction when viewing FIG. 3, resulting in the hook arm 73B closing the mouth 72B of the housing 72, and hence retaining the retention pin 27.

The latch striker 35 is retained by the rotatable claw 32 at substantially the same time as the retention pin 27 is retained by the auxiliary retention device 26. Accordingly, the auxiliary retention device 26 and the latch 18 are automatically synchronizing during closing. To open the door, the latch 18 is opened by any conventional manner. The subsequent sequence of events during opening is the reverse of the events that occur during closing. In other words, as the rotating claw 32 starts to release the latch striker 35, then at substantially the same time the hook 73 will start to release the retention pin 27. Thus, both the latch 18 and auxiliary retention device 26 are automatically synchronized during opening as well.

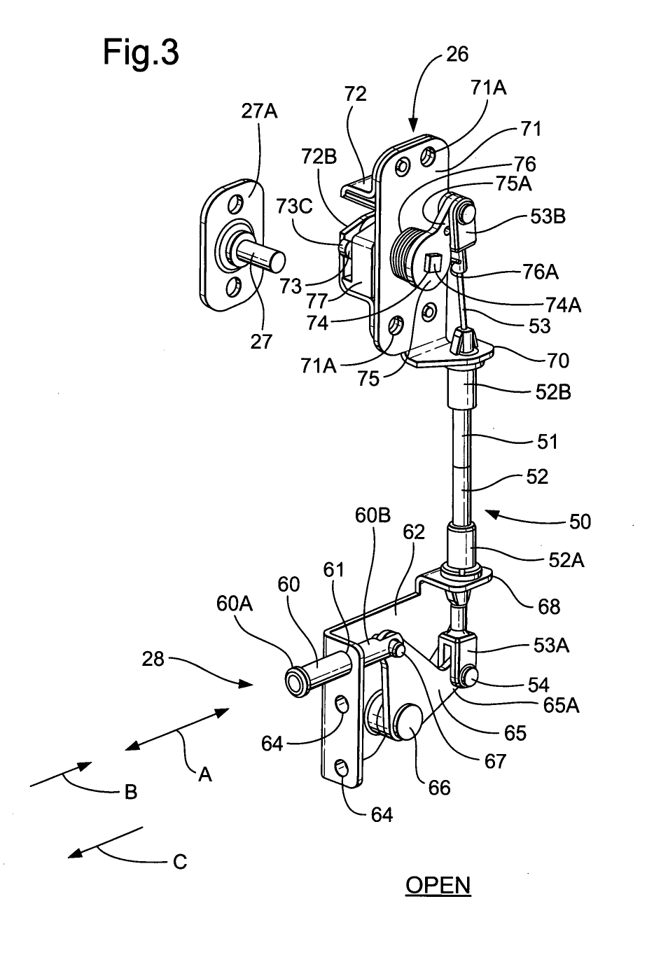

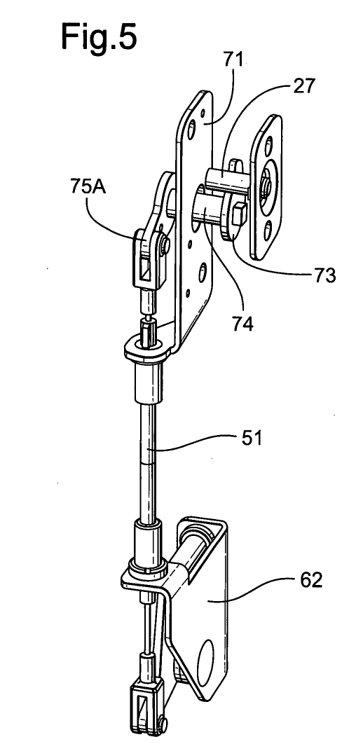

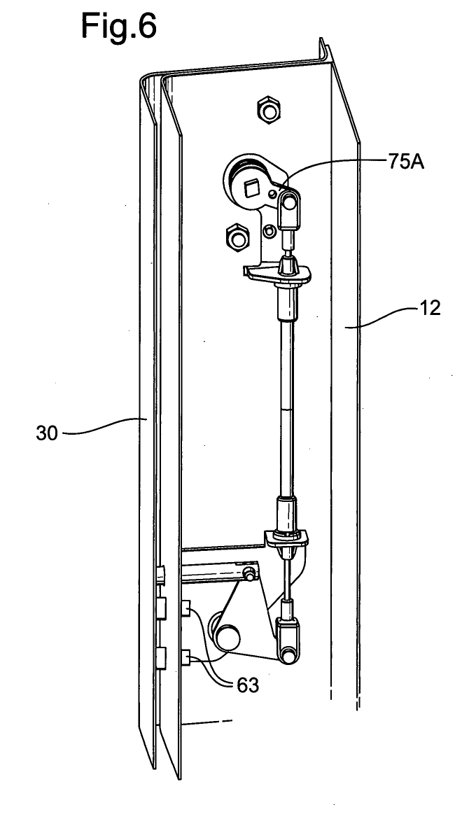

In summary then, when the door is in the fully closed position, the latch 18 and the latch striker 35 are positioned as shown in FIG. 2A, the auxiliary retention device 26 and the retention pin 27 are positioned as shown in FIGS. 4 to 6, and the plunger is positioned as shown in FIGS. 6 and 7.

To minimize ingress of rain and road noise, door seals are provided around a periphery of the door which engage with the door aperture, i.e., the aperture on the vehicle body within which the door sits. The seals are typically of an elastomeric material which is forced into a compressed state when the door is fully closed. To reduce road noise and wind noise, it is necessary to design the vehicle with an increased seal force. The seal force acts around the periphery of the door and tends to force the periphery of the door outwards relative to the vehicle body.

On known vehicles having a single latch at the rear of the door, the seal force is reacted by the door hinges and the single latch. However, because the latch is positioned below the belt line and the door frame above the belt line is relatively weak, the seal forces can tend to push the top of the door outwardly more relative to the bottom of the door (which is secured by the latch). In order words, the top of the door frame can tend to bend out relative to the bottom of the door.

In the embodiment of the present invention shown in FIG. 1, the door frame 22 is securely held in against the door seals by the auxiliary retention device 26. However, as mentioned above, the hook 73 of the auxiliary retention device 26 is not directly engaged by a pawl to hold it in a closed position. The hook 73 is held in its closed position by a force F1 acting on the end 60A of the plunger 60. The force F1 is clearly acting on the door in an opening direction. Of course, the door is prevented from opening by engagement between the pawl 38 and the rotating claw 32.

The auxiliary retention device 26 is positioned remotely from the latch 18. In particular, the auxiliary retention device 26 is positioned above the belt line 20, whereas the latch 18 is positioned below the belt line 20.

The actuator system 28, the main component of which is the plunger 60, is positioned remotely from the auxiliary retention device 26. In particular, the actuator system 28 is positioned below the belt line 20. The actuator system 28 is positioned proximate the latch 18.

The arrangement is such that forces generated at one part of the door are transferred to another part of the door via the transmission path 50. In this case, the door seal in the upper part of the door tends to force the upper part of the door outwards. The upper part of the door is prevented from bending outwards relative to the lower part of the door by the auxiliary retention device 26. The forces required to hold the hook 73 of the auxiliary retention device 26 closed are transferred via the transmission path 50 (in particular the bowden cable 51) to a lower part of the door. The lower part of the door is significantly stronger than the upper part of the door, and is therefore more able to resist the opening loads applied to the upper part of the door than the upper part of the door itself.

The manner of operation of the present invention can be contrasted with the manner of operation of the latches in EP1149968. In the present invention, the bowden cable 51 is used to hold the top part of the door closed. By way of example, if the bowden cable 51 were to fail, then the door would remain shut, but the top part of the door would spring outwardly by a small amount. Subsequent opening of the latch 18 would allow the door to be opened. Subsequent closing of the door would cause the latch 18 to relatch. However, the top of the door would still be sprung outwardly slightly (because the bowden cable is still assumed to have failed) by virtue of the adjacent door seals and hence, in use, wind noise and road noise within the vehicle would be increased slightly.

In summary, the bowden cable 51 acts to hold the top of the door closed and serves no purpose in actively opening the door.

This can be contrasted with the auxiliary latches of EP1149968 in which the associated bowden cable only serves the purpose of unlatching the auxiliary latches. By way of example, if the bowden cables in EP1149968 were to fail, then the door would shut properly with all door seals being compressed to their designed state and in use there would be no extra in vehicle road or wind noise. However, while it would still be possible to open the master latch, the auxiliary latches would not open and it would not be possible to open the door.

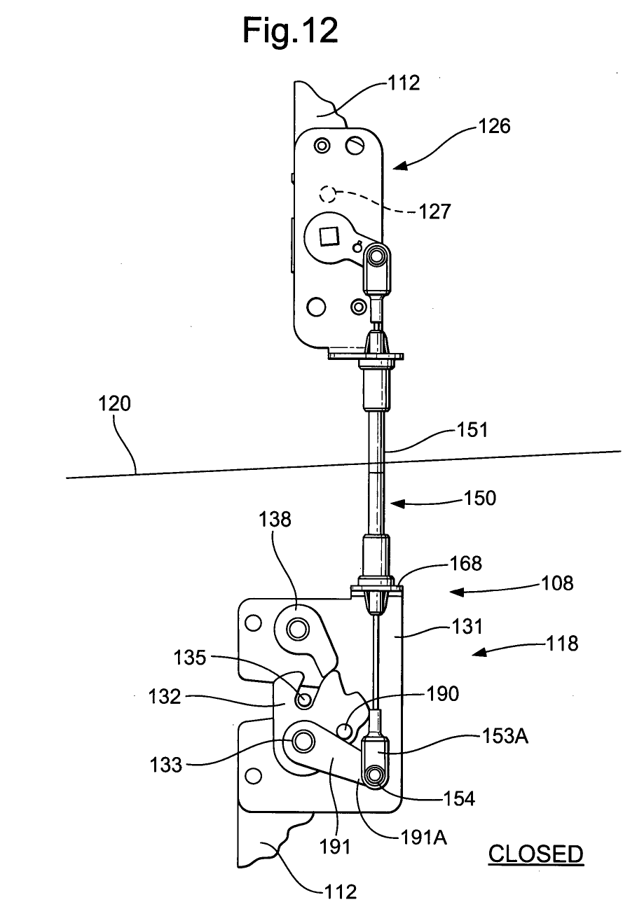

FIG. 12 shows a second embodiment of a latch system 108 of the present invention. An auxiliary retention device 126 of the latch system 108 is identical to the auxiliary retention device 26 of the latch system 8. A bowden cable 151 of the latch system 108 is identical to the bowden cable 51 of the latch system 8. A pawl 138 of the latch system 108 is identical to the pawl 38 of the latch system 8. The latch 118 is a self latching latch. The latch chassis 131 of the latch system 108 is identical to the latch chassis 31 of the latch system 8, other than the latch chassis 131 includes a tab 168 which is the equivalent of the tab 68 of the plate 62 on the latch system 8. The rotating claw 132 of the latch system 108 is identical to the rotating claw 32 of the latch system 8, other than the rotating claw 132 includes a drive pin 190.

As shown in FIG. 12, a drive lever 191 is rotatably mounted about a pivot 33 about which the rotating claw 132 rotates. An end 191A is pivotally attached to a cable inner end fitting 53A by a pin 54. In use, the latch system 108 is installed on a vehicle in a manner similar to the way in which the latch system 8 is installed on the car 10. The auxiliary retention device 126 is installed on the door 112 above the belt line 120, and the latch 118 is installed on the door 112 below the belt line 120. The retention pin 127 and the latch striker 135 are installed on an adjacent door pillar of the vehicle.

Operation of the latch system 108 is as follows. Starting with the door 112 in an open position (not shown), the latch striker 135 is positioned remotely from the rotating claw 132, and the retention pin 127 is positioned remotely from the auxiliary retention device 126. As the door is closed, the latch striker 135 enters the mouth of the rotating claw 132 as the retention pin 127 enters the mouth of the housing. As latch striker 135 engages a striker edge 134A (which acts as the engaging member) and starts to rotate the rotating claw 132 clockwise, the pin 190 engages a drive lever 191 and rotates the drive lever 191 in the clockwise direction. This causes a cable inner end fitting 153 to move generally downwardly as occurred during closing of the latch system 8. In the closed position shown in FIG. 12, the latch striker 135 is retained by the rotating claw 132, and the retention pin 127 is retained by the hook 173. The pawl 138 serves to hold both the rotating claw 132 in its closed position and the hook 173 in its closed position (by virtue of the transmission path 50.

Whereas the latch system 8 had a separate rotating claw 32 and engaging member (the end 60A of the plunger 60), the rotating claw 132 acts as both a claw and an engaging member. In particular, the striker edge 34A acts as the engaging member. Furthermore, whereas the latch system 8 included a latch striker 35 and a separate abutment region 81, the latch striker 135 of the latch system 108 fulfils both these functions. During closing, the latch striker 135 is in engagement with the striker edge 34A of the mouth 34. Once the door has been fully closed, the door seals push the door to a position where the latch striker 135 engages the retention edge 34B of the mouth 34.

There are many variations on the positioning of various components of latch systems according to the present invention on vehicles.

As shown in FIG. 1, the latch 18 the actuator system 28 and the auxiliary retention device 26 are all mounted on the front door with the retention pin 27 and the latch striker 35 being mounted on the B pillar. As previously mentioned, the front door 12 is hinged at a front end.

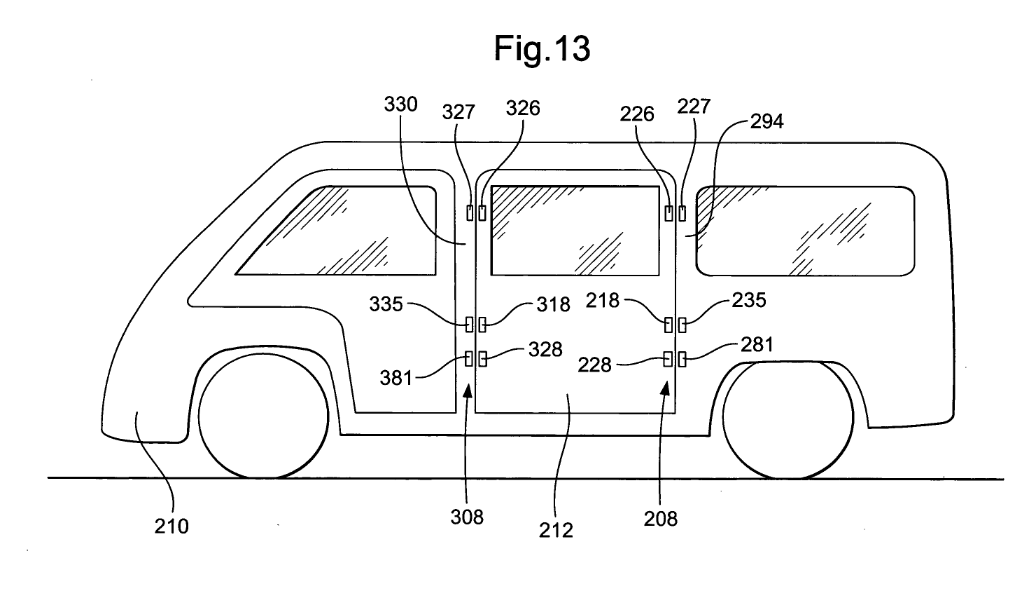

FIG. 13 shows a vehicle 210 having a sliding door 212 which slides rearwardly to open. A latch system 208 is provided in which components which fulfil substantially the same function as those of the latch system 8 are labelled 200 greater. In this case, a latch 218, an actuator system 228 and an auxiliary retention device 226 have been mounted on a rear edge of the sliding door. A retention pin 227, a latch striker 235 and an abutment region 281 are mounted/provided on a C pillar 294.

A latch system 308 is also provided in which components which fulfil substantially the same function as those of the latch system 8 are labelled 300 greater. The front edge of the sliding door 212 includes a latch 318, an actuator system 328 and an auxiliary retention device 326. A B pillar 330 includes a corresponding retention pin 327, a corresponding latch striker 335 and a corresponding abutment region 381.

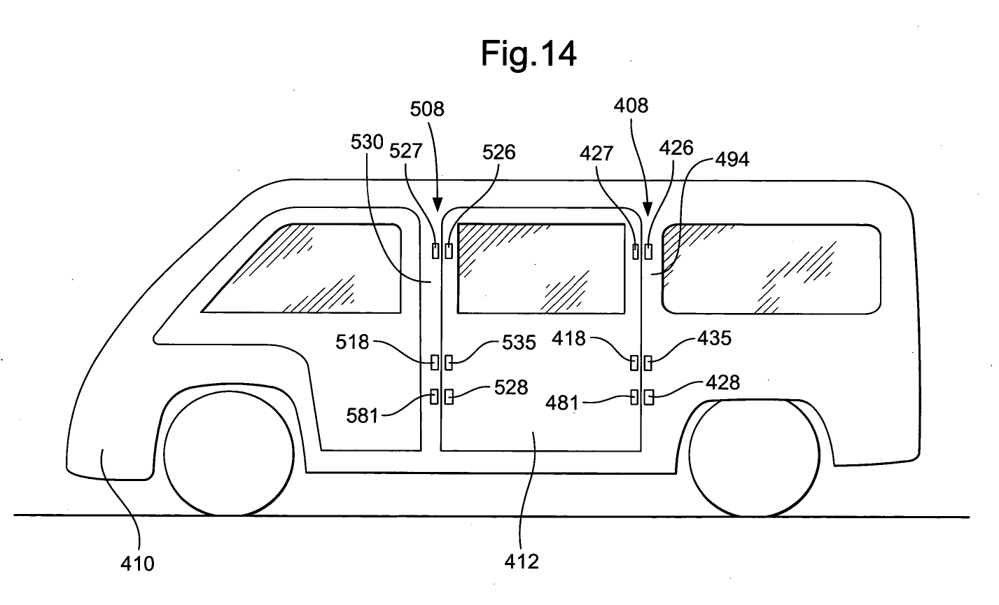

The front door 12 and the sliding door 212 all show latches, retention devices and actuator systems mounted on the same component i.e., on the same door. FIG. 14 shows a vehicle 410 having a sliding door 412 similar to the sliding door 212. A latch system 408 is provided at the rear of the sliding door 412 in which components that fulfils substantially the same function as those of the latch system 8 are labelled 400 greater. In this case, a latch 418 is mounted on the rear edge of the sliding door with a striker 435 being mounted on a C pillar 494. The rear edge of the sliding door also includes a retention pin 427 and an abutment region 481. In this case, the actuator system 428 and the auxiliary retention device 426 are mounted on the C pillar 494. A latch system 508 is also provided in the region of the front edge of the sliding door 412, in which components that fulfil substantially the same function as those of the latch system 8 are labelled 500 greater. The front edge of the sliding door 412 includes an auxiliary retention device 526, a latch striker 535 and an actuator system 528, whereas the B pillar 530 includes a retention pin 527, a latch 518 and an abutment region 581.

Thus, the retention device and associated actuator system can be mounted on one component e.g., a door, and the latch can be mounted on another component e.g., a door pillar.

It is not necessary to mount an actuator system and an auxiliary retention device on the same component. Thus, the rear door of FIG. 1 includes a latch system 608 in which components that fulfil substantially the same function as latch system 8 are labelled 600 greater. In this case, an auxiliary retention device 626 is mounted on the roof with an associated retention pin 627 being mounted in the door frame. The corresponding actuator system 628 is mounted at the rear of the door and cooperates with an abutment region 681 on the C pillar 694. Because the actuator system 628 is mounted on the door, which moves relative to the body of the vehicle, the transmission path must be designed to cope with the relative movement of the actuator system 628 relative to the auxiliary retention device 626. A typical transmission path 650 is shown in dotted lines, and it passes close to the hinges of the door.

The embodiments shown in FIGS. 1 to 14 all relate to how a single door (also known as an aperture closure) closes an aperture defined by the body of the vehicle. The invention is equally applicable to apertures that are closed by more than one door (i.e., are closed by more than one aperture closure), in particular apertures that are closed by two doors.

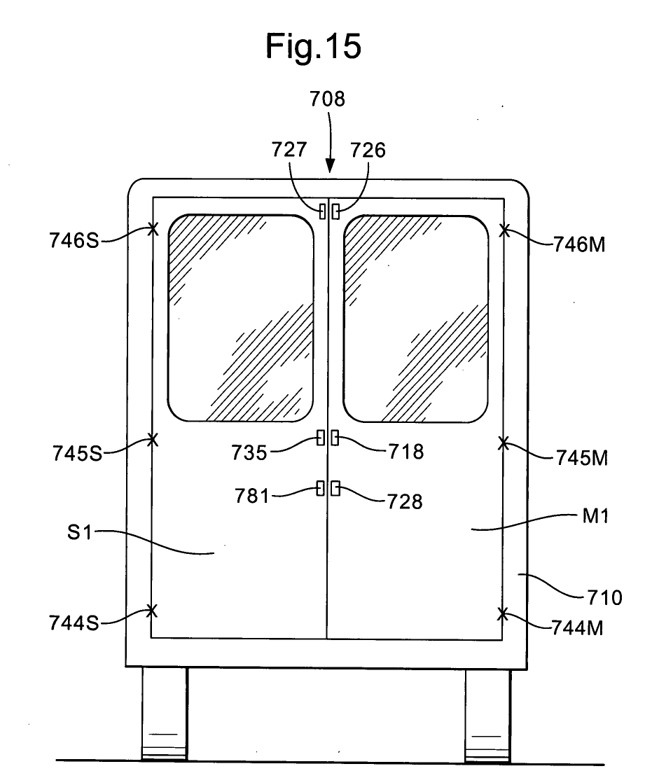

FIG. 15 shows the rear view of a van 710. In this case, the rear aperture of the van is closed by two doors, namely a slave door S1 and master door M1. To open the doors, the master door M1 must be opened first. With both doors open, the slave door S1 must be closed first and the master door M1 must be closed last. Thus, the total aperture to be closed is defined by a vehicle roof, a vehicle sides and a rear sill. The slave door S1 closes approximately half of its aperture, and the master door M1 closes the approximate other half of the aperture. However, because the slave door S1 must always be closed first, the aperture which the master door M1 closes is defined by the right hand edge of the slave door S1, the right hand side of the vehicle body, the right hand half of the roof and the right hand half of the rear sill.

The doors are provided with a latch system 708 in which components that fulfil substantially the same function as those of latch system 8 are labelled 700 greater. In this case, the master door M1 has a latch 718, an actuator system 728 and an auxiliary retention device 726 mounted on the left hand side of the master door (which is pivoted at its right hand side to open). A corresponding retention pin 727, a latch striker 735 and an abutment region 781 are provided on the right hand side of the slave door S1 (which is pivoted at its left hand side to open).

With both doors in an open position, it is necessary to close the slave door S1 first and secure it in position by means not shown. The master door M1 is then closed, and the latch 718, the actuator system 728 and the auxiliary retention device 726 operate in a manner equivalent to their corresponding components on the latch system 8.

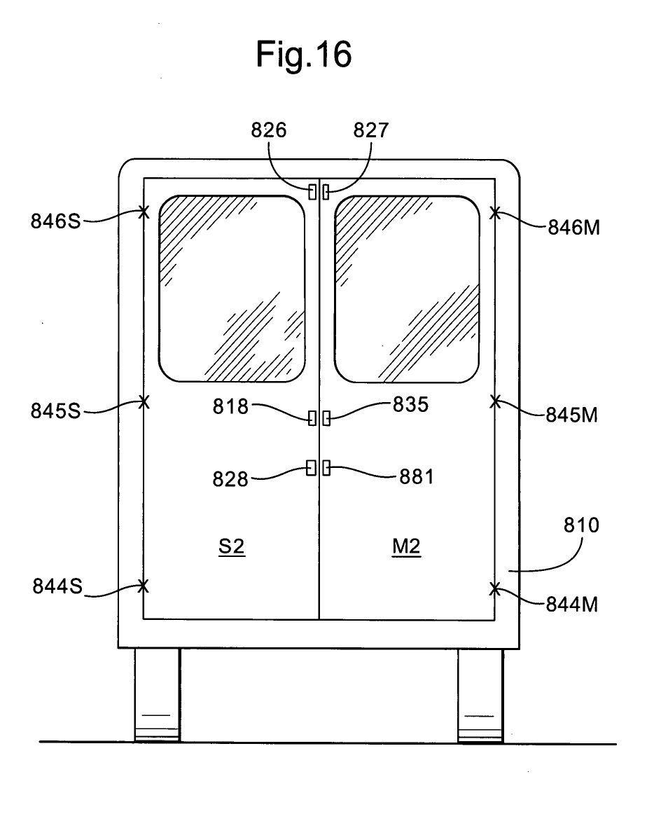

FIG. 16 shows a rear view of a van 810 having a slave door S2 and a master door M2 that open similarly to the slave door S1 and the master door M1. In this case, the latch 818, the auxiliary retention device 826 and the actuator system 828 have been positioned on the slave door S2, with a corresponding retention pin 827, a latch striker 835 and an abutment region 881 being positioned on the master door M2.

The position of the various components of latch systems 208, 308, 408, 508, 608, 708 and 808 have been described in relation to the latch system 8. Just as it was possible to replace the latch system 8 with the latch system 108, then it is equally possible to replace any of the latch systems 308, 408, 508, 608, 708 and 808 with a latch system the equivalent of latch system 108. Any of a latch and an auxiliary retention device and an actuator system can be mounted on any of a master door or a slave door with corresponding retention pin, a latch striker and an abutment region being mounted on the other of the master door or the slave door.

FIGS. 1 and 13 to 16 show variations of how a latch, an auxiliary retention device and an actuator system can be mounted on various doors. Embodiments shown in FIG. 12 shows a system where the actuator system has been incorporated into the latch. Accordingly, the latch of FIG. 12 can be mounted on a single hinged door, the front or rear of a single sliding door, a B pillar, a C pillar, a master door or a slave door. The auxiliary retention device 26 of FIG. 12 can either be mounted on the same component e.g., the same door or the same pillar) or it can be mounted on the corresponding component (e.g., if the latch is mounted on a door the auxiliary retention device can be mounted upon a door, pillar or vice versa or if the latch is mounted on a master door, an auxiliary retention device can be mounted on the slave door or vice versa).

Various ways in which the auxiliary retention device may be located in relation to the actuator system may also be appreciated from viewing FIG. 1. For example, the auxiliary retention device 26 is positioned substantially vertically relative to the actuator system 28, that is, they generally lie on the same vertical axis. In this case, the auxiliary retention device 26 is generally vertically above the actuator system 28. Similarly, the auxiliary retention devices 226, 326, 426, 526, 726 and 826 are positioned substantially vertically above their associated actuator system 228, 328, 428, 528, 728 and 828, respectively. In these examples, the retention device is positioned generally vertically above the associated actuator system, but in further embodiments, the retention device could be positioned generally vertically below the associated actuator system.

Consideration of FIG. 1 shows that the auxiliary retention device 626 is positioned near the top front of the rear door 14, and its associated actuator system 628 is positioned approximately half way up the rear edge of the door. Accordingly, the auxiliary retention device 26 is not positioned substantially vertically above the actuator system 628. Nevertheless, because the auxiliary retention device 626 is positioned near the top of the door, and the actuator system 628 is positioned part way up the door, the auxiliary retention device 626 is vertically spaced relative to the actuator system 628, i.e., the engaging member is positioned at a different height from the auxiliary retention device 626.

Consideration of FIG. 1 shows that the front door 12 has an upper hinge 44 and a lower hinge 46 (shown schematically). The upper hinge 44 and the lower hinge 46 allow the door to pivot open about a hinge axis H. The hinge axis H therefore defines a single axis about which the front door 12 opens, i.e., when the front door 12 opens, it only rotates about the hinge axis H (contrary to the hinge mechanism shown in U.S. Pat. No. 3,206,239). The hinges 644, 646, 744S, 745S, 746S, 744M, 745M, 746M, 844S, 845S, 846S, 844M, 845M and 846 also ensure that their associated doors pivot about a single axis.

The auxiliary retention device 26 is positioned on an opposite side of the door from the hinges 44 and 46, the auxiliary retention device 726 is positioned on an opposite side of it's door from hinges 744M, 745M and 746M, and the auxiliary retention device 826 is positioned on an opposite side of its door from the hinges 844S, 845S and 846S.

The auxiliary retention device 26 is positioned higher than the hinges 44 and 46, in particular higher than the upper hinge 44. The auxiliary retention device 726 is positioned higher than the upper hinge 746M. The auxiliary retention device 826 is positioned higher than the upper hinge 846S. The auxiliary retention device 626 is positioned higher than the upper hinge 644.

In summary, the auxiliary retention devices 26, 626, 726 and 826 are all spaced vertically relative to the associated hinges. In this case, the auxiliary retention devices 26, 626, 726 and 826 are spaced vertically higher than the associated hinges.

In further embodiments, the auxiliary retention device could be positioned vertically lower than the lower hinge 46, the auxiliary retention device 626 could be positioned lower than the hinge 646, the auxiliary retention device 726 could be positioned lower than the upper hinge 744, or the auxiliary retention device 826 could be positioned lower than the upper hinge 844S.

In further embodiments, the auxiliary retention device 626 could be positioned higher than the upper hinge 44, but lower than the belt line 20. Similarly, in a further embodiment, the auxiliary retention device 626 could be positioned higher than the upper hinge 644, but lower than the belt line 20.

As mentioned above, there are various ways in which the auxiliary retention device may be located in relation to the engaging member. The auxiliary retention device 126 can be positioned in any of the positions mentioned herein in relation to the other auxiliary retention devices.

The latch system 108 can be mounted on an aperture closure or an aperture. The auxiliary retention device 126 could be mounted on an aperture closure, a further aperture closure or an aperture, independently of whatever component the latch system 108 is mounted on.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A latch system for an aperture closure, the latch system comprising:
a latch;
an auxiliary retention device remote from the latch;
an engaging member remote from the auxiliary retention device, wherein the engaging member is positioned at a different height from the auxiliary retention device; and
a transmission path operably connecting the engaging member with the auxiliary retention device, wherein the latch system is arranged such that movement of the aperture closure from an open position to a closed position causes the latch to move to a closed position, and causes movement of the engaging member to cause the transmission path to move the auxiliary retention device to a closed position.

2. The latch system as defined in claim 1 wherein the latch is mounted on the aperture closure and a latch striker is mounted on one of an aperture or a further aperture closure.

3. The latch system as defined in claim 1 wherein the latch is mounted on an aperture and a latch striker is mounted on the aperture closure.

4. The latch system as defined in claim 1 wherein the engaging member is mounted on the aperture closure.

5. The latch system as defined in claim 1 wherein the engaging member is mounted on an aperture.

6. The latch system as defined in claim 1 wherein the auxiliary retention device is mounted on the aperture closure, and a retention keep is mounted on one of an aperture or a further aperture closure.

7. The latch system as defined in claim 1 wherein the auxiliary retention device is mounted on an aperture, and a retention keep is mounted on the aperture closure.

8. The latch system as defined in claim 1 wherein the engaging member is defined by a latch bolt of the latch.

9. The latch system as defined in claim 1 wherein the engaging member is a separate component from a latch bolt of the latch.

10. The latch system as defined in claim 1 wherein the transmission path includes a bowden cable.

11. The latch system as defined in claim 1 wherein the latch includes a latch bolt and a pawl, and with the aperture closure in the closed position, a first opening force applied to the latch bolt is reacted by the pawl, and a second opening force applied to the auxiliary retention device is reacted by the pawl.

12. The latch system as defined in claim 10 wherein the latch includes a latch bolt and a pawl, and with the aperture closure in the closed position, a first opening force applied to the latch bolt is reacted by the pawl, and a second opening force applied to the auxiliary retention device is reacted by the pawl, and the opening force applied to the auxiliary retention device is transmitted as a tensile load in the bowden cable to the pawl.

13. The latch system as defined in claim 1 wherein the aperture closure is connected to an aperture by a hinge mechanism which defines a single axis about which the aperture closure rotates.

14. The latch system as defined in claim 13 in wherein the auxiliary retention device is positioned on a side of the aperture closure opposite from the hinge mechanism.

15. The latch system as defined in claim 1 wherein the aperture closure is connected to an aperture by a hinge mechanism, and the auxiliary retention device is positioned on a side of the aperture closure opposite from the hinge mechanism.

16. The latch system as defined in claim 1 wherein the engaging member and the auxiliary retention device are positioned substantially vertically relative to each other.

17. The latch system as defined in claim 13 wherein the aperture closure is a vehicle door having a belt line, and the auxiliary retention device is mounted below the belt line and vertically spaced above the hinge mechanism.

18. The latch system as defined in claim 1 wherein the aperture closure is a sliding door.

19. The latch system as defined in claim 1 wherein the aperture closure is a vehicle door having a belt line, the latch and the engaging member are mounted below the belt lines and the auxiliary retention device is mounted above the belt line.

20. A latch system comprising:
a latch having a latch bolt and a pawl;
an auxiliary retention device remote from the latch; and
a transmission path operably connecting the latch bolt to the auxiliary retention device, wherein closing of the latch causes the transmission path to move the auxiliary retention device to a closed position.

21. A method of closing an aperture closure and retaining the aperture closure in a closed position, the method comprising the steps of:
moving the aperture closure from an open position to the closed position so as to move a self-engaging latch to a closed position to self latch, and to cause an actuator system on one of an aperture and the aperture closure to actuate by engagement with the other of the aperture and the aperture closure, thereby causing a transmission path to move an auxiliary retention device to a closed position,
wherein the actuator system is provided remote from the auxiliary retention device, the auxiliary retention device is remote from the latch, and the transmission path operably connects the actuator system and the auxiliary retention device.

22. The method as defined in claim 21 further including the steps of:
applying a first opening force to the self-engaging latch and reacting the first opening force at a pawl of the self-engaging latch, and
applying a second opening force to the auxiliary retention device and transmitting the second opening force via the transmission path to the pawl to react the second opening force at the pawl.

23. The method as defined in claim 22 further including the step of transmitting the second opening force via a bowden cable in the transmission path.
